(19) United States
(12) Patent Application Publication
(10) Pub. No.: US 2023/0407572 A1
(43) Pub. Date: Dec. 21, 2023

(54) IMPREGNATED CORE PAPER FOR DECORATIVE LAMINATE

(71) Applicant: AHLSTROM-MUNKSJÖ OYJ, Helsinki (FI)

(72) Inventor: Andrea MÜHLBAUER, Apprieu (FR)

(21) Appl. No.: 18/032,714

(22) PCT Filed: Oct. 20, 2021
(86) PCT No.: PCT/FI2021/050699

§ 371 Date: Apr. 19, 2023

(30) Foreign Application Priority Data
Oct. 20, 2020 (FR) 2010767

(51) Int. Cl. D21H 17/56; D21H 17/37; D21H 17/53; D21H 17/67

(52) U.S. Cl. CPC D21H 17/56; D21H 17/37; D21H 17/53; D21H 17/67

(57) ABSTRACT

An impregnated core paper for a decorative laminate, in particular high-pressure decorative laminate, obtained by impregnating a paper substrate with an aqueous impregnating composition including one or more resins selected from melamine-ether resins, acrylic resins, epoxy resins, and mixtures thereof.

### TECHNICAL FIELD

This invention relates to the field of core papers, and in particular impregnated core papers, for the production of decorative laminates.

### PRIOR ART

Decorative laminates are generally used for surface finishing in the production of furniture, worktops, such as kitchen worktops, floor coverings, in particular, to imitate wooden floors, window frames, or exterior coverings, among others.

There are two main types of decorative laminates: those are known as high-pressure (HPL or “High-Pressure Laminates”) and those known as low-pressure (LPL or “Low-Pressure Laminates”).

High-pressure decorative laminates (HPL) are typically made from a core of a plurality of core sheets impregnated with a resin composition. Typically, each core sheet is made from a low-refined cellulose-based paper, such as Kraft paper, which has been impregnated with a thermosetting resin composition, typically a synthetic phenol-formaldehyde resin composition. After impregnation with the thermosetting resin composition, the core sheets are dried, cut into sheets, and stacked on top of each other. The number of core sheets in the core sheet stack depends on the application. It may vary between 3 and 9 but may be higher or lower. The role of the core is to impart mechanical strength to the final HPL decorative laminate. It also makes it possible to obtain the required thickness of the final HPL laminate, including adjusting the number of core sheets in the core sheet stack.

A decorative paper impregnated with a thermosetting resin composition, typically a melamine-formaldehyde resin composition, is then placed on the stack of Kraft paper sheets impregnated with a phenol-formaldehyde resin composition that forms the core. Decorative paper is generally a sheet of colored paper, with or without a printed pattern and/or decorative particles. Decorative paper is used to give a particular aesthetic aspect to the core upon which it is affixed. It will hide the core, by its opacity, and impart a color if it is a plain colored paper or a pattern if it is a printed decorative paper. Traditionally, this printed decorative pattern involves an imitation of the appearance of a natural material, such as wood or marble, but may also represent more geometric patterns depending on the creativity of the designers.

In general, for the production of high-pressure decorative laminates, an overlay is placed on top of the decorative paper, especially when the decorative paper has a printed pattern. The protective sheet is usually impregnated with a melamine-formaldehyde resin composition. The protective film is unpatterned, and the final HPL laminate has a transparent appearance. The purpose of this protective film is to improve the resistance to abrasion of the final HPL laminate.

The stack of impregnated sheets, i.e., the stack of impregnated core sheets forming the core, the impregnated decorative paper sheet, and the impregnated protective sheet, is then placed in a laminating press. The platens of this press are provided with a plate that imparts the desired surface finish to the laminate. The stack is assembled by heating to a temperature that is within the general range of 110° C. to 170° C. and at a pressure in the general range of 5.5 MPa to 11 MPa for a time sufficient to cure the resins impregnating the sheets of the stack, on the order of 25 to 60 minutes. The elevated temperature and pressure allow the resin compositions impregnating the sheets in the stack to flow, cure, and bond the sheets to each other in a unitary structure corresponding to the HPL laminate. This unitary structure is then attached to a support layer that serves as reinforcement. The unitary structure is, for example, glued to plywood, hardboard, particleboard, in particular particleboard, or the like.

It is also possible to obtain high-pressure laminates using a so-called “dry process,” which consists of using a decorative paper not impregnated with a thermosetting resin composition, generally sandwiched between a barrier paper impregnated with a resin composition positioned underneath, and a protective overlay sheet also impregnated with a resin composition and positioned above. There are variants where the overlay protection sheet is not placed on top but underneath. Impregnation of the decor paper with the resin composition occurs when pressure is exerted upon the stack of individual sheets by diffusion of the resin composition out of the barrier and overlay paper sheets with which the decor paper is in contact or proximity thereof.

When a less expensive and less durable laminate is required, so-called low-pressure decorative laminates (LPL) may be used. LPL laminates are produced using only a decor paper impregnated with a thermosetting resin composition and optionally a protective overlay sheet, which is laminated directly onto the backing layer, usually a wood panel (e.g., chipboard, in medium or MDF panel, plywood, etc.). The lamination step is carried out at a temperature between 160° C. and 200° C. and at a pressure between 1.25 MPa and 3 MPa for a short time. For this reason, the LPL process is generally referred to as a short cycle or low-pressure process. The removal of the core results in a laminate that is less expensive to manufacture but does not offer the chemical and mechanical strength and durability of HPL laminates.

In addition to the high-pressure and low-pressure processes, there is a continuous laminating process called CPL (“continuous pressed laminates”), which is similar to the high-pressure process, but where papers unwound from reels are used instead of pre-cut sheets.

Because formaldehyde is considered a harmful substance to health, precautions must be taken when handling impregnating resin compositions containing this substance, which makes the production of decorative laminates more complex. In addition, formaldehyde residues in decorative laminates are considered indoor air pollutants. Thus, manufacturers are constantly looking for processes to make decorative laminates that emit less or no formaldehyde.

Despite this need for formaldehyde-free impregnating resin compositions, the Kraft paper sheets forming the core of conventional HPL laminates are still mostly impregnated, with a degree of saturation between 30% and 40%, with a synthetic phenol-formaldehyde resin composition, i.e., made from the reaction of phenols with formaldehyde.

Typically, the Kraft paper sheet is first pre-moistened with the phenol-formaldehyde resin composition by bringing one side of the sheet into contact with the surface of a phenol-formaldehyde resin bath via a roller system. This pre-wetting step is used to eliminate the air trapped in the sheet and to start quick soaking with the resin. The removal of trapped air is completed by passing the sheet through rollers (“aeration step with sky rolls”). The sheet is then impregnated by total immersion in the phenol-formaldehyde resin bath (“soaking step”), then passed through a pair of rollers (“squeezing rolls”) to remove the excess phenol-formaldehyde resin. Thus, the step of impregnating the Kraft paper sheets is carried out in a conventional off-line way on specific equipment which is not part of the paper machine. This specific equipment operates at a paper running speed between 50 and 250 m/min.

Document EP0473335 describes a solvent-based resin composition used for impregnating core sheets. The solvent used in this resin composition is a ketone containing up to 8 carbon atoms, such as methyl ethyl ketone, acetone, or methyl isobutyl ketone, which are environmentally hazardous organic solvents.

Document EP2767392 discloses a decorative panel that is fire resistant. This decorative panel comprises an inorganic fibrous substrate, for example with glass fibers, rock wool, or carbon fibers, which is pre-impregnated. This document states that the use of inorganic fibrous substrates is advantageous over organic fibrous substrates since it improves the fire resistance properties of the decorative panel. Such inorganic fibrous substrates, however, have structure and resin impregnation properties that are not comparable to cellulose-based paper substrates, such as Kraft paper, typically used for the manufacture of decorative HPL.

There is a need for faster and easier production of impregnated core papers for the manufacture of decorative laminates that are less harmful to health and the environment, while performing at least as well, especially in terms of strength and durability, as conventional decorative laminates, especially those comprising Kraft paper sheets impregnated with a phenol-formaldehyde resin composition.

### DISCLOSURE OF THE INVENTION

### Impregnated Core Paper

The invention meets this need, according to one of its aspects, by means of an impregnated core paper for a decorative laminate, in particular high-pressure decorative laminate, obtained by impregnating a paper substrate with an aqueous impregnating composition comprising one or more resins selected from melamine-ether resins, acrylic resins, epoxy resins and mixtures thereof.

The impregnating composition is an aqueous composition that may be substantially free of organic solvent.

The impregnating composition may be substantially free of phenol-formaldehyde resin.

The impregnating composition may be substantially free of free-formaldehyde. The “free-formaldehyde” content in the resin of the impregnating composition can be determined according to ISO 11402:2004.

We should understand that “substantially free of phenol-formaldehyde” means that the impregnating composition comprises respectively less than 5% by dry weight of phenol-formaldehyde resin, better less than 2% by dry weight, still better less than 1% by dry weight. We should understand that “substantially free of organic solvent” means that the impregnating composition comprises respectively less than 5% by dry weight of organic solvent, better less than 2% by dry weight, still better less than 1% by dry weight. We should understand that “substantially free of free-formaldehyde” means that the impregnating composition comprises respectively less than 5% by dry weight of free-formaldehyde, better less than 2% by dry weight, still better less than 1% by dry weight, or even less than 0.5% or 0.1% by dry weight as determined according to ISO 11402:2004.

Thus, such an impregnation composition is less harmful to health and the environment, especially compared to conventional phenol-formaldehyde resins and resins containing high amounts of free-formaldehyde.

Lamination of the impregnated core paper sheets, according to this invention, results in a core that has good cohesion, i.e., the sheets are sufficiently bonded to each other.

On the other hand, the invention allows this cohesion to be maintained when the decorative laminate is subjected to the resistance to boiling water immersion test described in the standard DIN EN 438-2:2019-03, i.e., the decorative laminate is strong enough to not delaminate, and that swelling of the decorative laminate is limited (limited increase in its thickness and mass).

The cohesion and strength of the decorative laminate obtained by laminating the impregnated core paper sheets according to the invention are at least comparable with the decorative laminates known from the prior art, i.e., comprising Kraft paper sheets impregnated with conventional phenol-formaldehyde type resins.

Remarkably, the achievement of this cohesion and strength is furthermore possible with reduced amounts of impregnating composition within the impregnated core paper, i.e., with reduced degrees of saturation, especially in comparison with the degrees of saturation of Kraft paper sheets impregnated with conventional phenol-formaldehyde type resins. This may reduce the cost of manufacturing impregnated core papers.

The “degree of saturation” is defined as the ratio of the dry weight of the impregnation composition to the total dry weight of the impregnated core paper.

Thus, the impregnated core papers, according to the invention, are able to replace the core paper sheets impregnated with conventional phenol-formaldehyde type resins and provide a performance that is at least comparable while being less harmful to health and the environment and less expensive.

In some embodiments, the impregnating composition may comprise a melamine-ether resin, in particular at least 90%, better still at least 95%, by dry weight of a melamine-ether resin, or an acrylic resin, in particular at least 90%, better still at least 95%, by dry weight of an acrylic resin, or a mixture of epoxy resin and hardener, in particular at least 90%, better still at least 95%, by dry weight of this mixture. More particularly, the epoxy resin and hardener mixture comprises between 5% and 25%, preferably between 10% and 20%, by dry weight of hardener in the mixture. The term “hardener” is understood to mean a cross-linking agent. The hardener may be of the polyamide type or of any other type that makes hardening of epoxy resins possible.

In some embodiments, the impregnating composition may comprise melamine-ether resin, in particular at least 25% by dry weight of a melamine ether resin, or an acrylic resin, in particular at least 55%, better still at least 70% by dry weight of an acrylic resin, or their combination.

The melamine-ether resin may be an ultra-low formaldehyde melamine-ether resin. The free-formaldehyde content in said resin may be less than 1% by dry weight or even less than 0.1% by dry weight.

The impregnating composition may comprise a water-soluble polymer. This water-soluble polymer may, for example, be a starch, modified starch, carboxymethyl cellulose (CMC), guar gum, polyvinyl alcohol, or mixtures thereof. The water-soluble polymer is preferably selected from a starch, a modified starch, a polyvinyl alcohol, and mixtures thereof. The modified starch may be a starch modified by physical, enzymatic, chemical, and/or thermal treatment. The starch and/or modified starch may be derived from corn, potatoes, wheat, rice, and/or tapioca.

In some embodiments, when the impregnating composition comprises a water-soluble polymer, the water-soluble polymer preferably represents 45% or less of the dry weight of the impregnating composition, and the acrylic, melamine-ether, epoxy resin, or mixtures thereof may, in particular, be present in an amount of at least 55%, preferably at least 70%, or at least 92% by dry weight of the impregnating composition.

In other different embodiments, the water soluble polymer may represent more than 45%, as much as 70% or 90% of the dry weight of the impregnating composition and the acrylic, melamine-ether, epoxy resin, or mixtures thereof which may, in particular, be present in an amount of less than 55%, preferably less than 30%, or even less than 10% by dry weight of the impregnating composition.

Water-soluble polymer from renewable resources are preferred because they reduce the carbon footprint of the product. Examples of renewable water-soluble polymers include starch and/or carboxymethyl cellulose.

The acrylic resin may be a styrene-acrylic latex.

The impregnating composition may be colorless. This differs from conventional phenol-formaldehyde resins, which are usually yellow or brown in color. Thus, the invention is able to make it possible to control the final color of the impregnated core paper, especially by playing up the color of the paper substrate or by adding organic or inorganic dyes to the impregnation composition so as to obtain the desired color for the impregnated core paper.

The paper substrate may comprise at least 45% dry weight, better still at least 90% dry weight, even better still at least 95% dry weight of cellulose fibers based on the total dry weight of the paper substrate.

The cellulose fibers may be short fibers, long fibers, or a mixture of short and long fibers.

Cellulose fibers may be obtained from wood, especially eucalyptus or other trees, or other plant materials such as cotton, hemp, linen, bamboo, or mixtures thereof.

The paper substrate may comprise cellulose fibers and at least one thermofusible synthetic compound in a mass ratio by dry weight greater than or equal to 1:1 and less than or equal to 15:1 of the totality of the cellulose fibers relative to the totality of the thermofusible synthetic compound(s), more preferably greater than or equal to 1:1 and less than or equal to 10:1, even more preferably greater than or equal to 1:1 and less than or equal to 4:1.

“Paper substrate” is understood to mean a substrate obtained by the papermaking process, also known as the wet process, i.e., obtained via a common papermaking process, in particular on a Fourdrinier type paper machine.

“Thermo-fusible synthetic compound” is understood to mean a compound comprising one or more synthetic polymers, obtained from a chemical synthesis, in particular by a monomer polymerization reaction, coupled or not with a cross-linking reaction, this compound exhibiting cohesive properties after melting following a thermal energy input.

The applicant has found that the presence of the thermofusible synthetic compound in the paper substrate is particularly advantageous because it makes it possible for the porous structure of the paper substrate to be modified and thus improve the absorption rate of the impregnating composition (reduction of the time required for impregnation).

The presence of the thermofusible synthetic compound is also particularly advantageous because when a sheet of impregnated core paper according to the invention is laminated with overlying and/or underlying sheets, in particular sheets of impregnated core paper and/or decorative paper, so as to obtain a decorative laminate, the thermofusible synthetic compound acts as an adhesive after melting following the supply of thermal energy and subsequent cooling. Thus, the adhesion of the impregnated core paper sheet according to the invention with the overlying and/or underlying sheets is improved, which makes it possible to improve the internal cohesion of the decorative laminate obtained in comparison with a core paper formed only with cellulose fibers.

The presence of cellulose fibers in the paper substrate, according to the invention, plays an important role in the fixation of the thermofusible synthetic compound. A mass ratio by dry weight (total cellulose fibers/total thermofusible synthetic compound(s)) greater than or equal to 1:1 is particularly advantageous because such a ratio can allow the thermofusible synthetic compound to be set in the best possible way in the fibrous structure formed by the cellulose fibers and thus ensure greater cohesion of the paper substrate necessary for a subsequent impregnation step.

Preferably, the thermofusible synthetic compound has good compatibility with cellulose fibers as well as with the wet paper process. For example, this compatibility may be improved by a surface treatment of the thermofusible synthetic compound.

The thermofusible synthetic compound may include or be made from a thermoplastic polymer.

The thermoplastic polymer may be selected from the families of acrylic polymers, polyurethanes, polyolefins, in particular, polyethylene (PE), polypropylene (PP), ethylene-vinyl acetate (EVA), ethylene acrylic acid (EAA), ethylene methacrylate (EMA), ethylene methyl methacrylate (EMMA) polyvinylidene chloride (PVDC), polyesters (PES), in particular, polyethylene terephthalate (PET), polylactic acid (PLA), polyamides, polyvinyl alcohol (PVA or PVOH), polyvinyl chloride (PVC), ethylene vinyl alcohol (EVOH), polyvinylidene fluoride (PVDF), copolymers thereof and mixtures thereof

The thermofusible synthetic compound may be in dispersed form, particularly in the form of a powder and/or fibers. The powder may comprise mono-component or multi-component particles, in particular bi-component particles of the core/sheath type, for example, or mixtures thereof. The powder may comprise mono-component or multi-component particles, in particular bi-component particles of the core/sheath type, for example, or mixtures thereof.

The thermofusible synthetic compound may be distributed at least in part in the mass of the papermaking substrate. This allows the thermofusible synthetic compound to interact more with the cellulose fibers and thus be retained more by the fibrous structure formed by the cellulose fibers. Indeed, as mentioned above, the presence of cellulose fibers plays an important role in the setting of the thermofusible synthetic compound.

In the case where the thermofusible synthetic compound is in the form of fibers, the entanglement of the synthetic thermofusible fibers with the cellulose fibers further improves the cohesion of the paper substrate.

The cellulose fibers may be obtained from traditional pulp manufacturing processes, in particular the so-called “Kraft process” used by ENCE, CMPC, SUZANO, UPM, METSA, STORA ENSO, etc. On the other hand, a distinction is made between the long fibers obtained from softwood and the short fibers obtained from hardwood.

The number-average diameter of the synthetic thermofusible fibers is, for example, between 5 and 20 μm, especially between 10 and 18 μm. The number-average length of the synthetic thermofusible fibers is, for example, between 0.5 and 15 mm, especially between 2 and 11 mm. The number-average linear density of the thermofusible synthetic fibers is for example between 0.5 and 3.5 dtex, in particular between 1 and 3 dtex (1 dtex=0.1 mg/m).

For example, the paper substrate may comprise single-component thermofusible synthetic fibers of polyethylene (PE), polypropylene (PP), polyethylene terephthalate (PET), or polyvinyl alcohol (PVOH).

In particular, it may be the single-component PVOH thermofusible synthetic fibers marketed by the company Kuraray under the reference KURALON VPB101 (linear mass or titration of 2.6 dtex, a diameter of 17 μm, length of 4 mm, and melting point of 80° C.).

For example, the paper substrate may comprise synthetic bi-component thermofusible fibers (also known as BiCo fibers) of the core/sheath type, including polyester/polyolefin, for example, PET/PE, polyolefin/polyolefin, for example, PP/PE, polyester/co-polyester, for example, PET/Co-PET, or PET/EVOH (core/sheath).

Preferably, the melting point of the sheath is lower than that of the core. In particular, this may allow the post-melting bark to act as an adhesive and the core to remain integrated so as to maintain a homogeneous fibrous structure within the paper substrate.

The two-component synthetic thermofusible fibers of the core/sheath type may be concentric and/or eccentric. The core to bark ratio can vary from 50/50 to 90/10.

In particular, it may be the bi-component thermofusible synthetic fibers of the PET/Co-PET core/sheath type (i.e., PET core and Co-PET sheath) marketed by the company Kuraray under the reference N720 (linear mass or titration of 2.2 dtex, 14 μm diameter, 5-10 mm length and 110° C. melting point) or N720H (2.3 dtex density, 15 μm diameter, 5 mm length and 130° C. melting point).

Preferably, the thermofusible synthetic compound is selected so that it has a melting point close to the temperature used during the lamination process so that it only melts when the core paper impregnated according to the invention is laminated to form a decorative laminate and does not melt prior to this lamination step, such as during the step of making the paper substrate on the paper machine or during the step of impregnating the paper substrate. Indeed, a melting of the thermofusible synthetic compound which would take place before the lamination step, would block the porosity of the paper substrate and would thus cause a strong degradation of the absorption capacity of the impregnation composition by the paper substrate. On the other hand, the melting of this thermofusible synthetic compound on the paper machine would clog the paper machine and interfere with the production of this paper substrate or the proper operation of the paper machine.

In particular, the melting point of the thermofusible synthetic compound is selected to be sufficiently high so that the thermofusible synthetic compound does not melt during the drying of the paper substrate during the production of the paper substrate on the paper machine or during its drying after impregnation.

The thermofusible synthetic compound may have a melting point greater than or equal to 80° C., greater than or equal to 90° C., even greater than or equal to 100° C.

The thermofusible synthetic compound may have a melting point lower than or equal to 200° C., lower than or equal to 190° C., even lower than or equal to 180° C.

In particular, the thermofusible synthetic compound may have a melting point between 105° C. and 150° C.

In the case where the thermofusible synthetic compound is in the form of core/sheath type bi-component particles and/or core/sheath type bi-component fibers, the melting point of the thermofusible synthetic compound corresponds to the melting point of the sheath (i.e., forming the outermost layer of the particle or fiber).

The paper substrate may have a basis weight before impregnation of between 40 and 400 g/m², preferably between 50 and 200 g/m². The basis weight of the paper substrate is determined according to ISO 536 after packaging according to ISO 187.

The paper substrate may have an air permeability measured by the Gurley method of between 1 and 60 sec, preferably between 5 and 30 sec. Air permeability measured by the Gurley method is determined according to ISO 5636-5:2013. Such air permeability is generally associated with good resin impregnation properties.

The paper substrate may comprise at least one filler and/or at least one pigment, in particular selected from mineral pigments, such as for example titanium dioxide, clays, calcined clays, talc, calcium carbonate, iron oxides, kaolin, calcined kaolin, diatomaceous earth, silicas, especially colloidal silicas, organic pigments, such as azo compounds or naphthols, synthetic pigments, barium sulfate, aluminum tri-hydrate and mixtures thereof, preferably selected from titanium dioxide, calcined clays and mixtures thereof.

The presence of a filler and/or a pigment can modify the porous structure of the paper substrate and allow it to be impregnated with the impregnating composition more quickly and more homogeneously.

The dry weight of the filler and/or pigment may be between 5% and 40%, preferably between 8% and 36%, of the total dry weight of the impregnated core paper. The dry weight of the filler and/or pigment is measured for a mineral filter according to ISO 2144.

The size D50 by mass of the filler and/or pigment preferably ranges from 0.05 to 30 microns, preferably from 0.1 to 15 microns.

Preferably, the filler and/or pigment are present in the bulk of the paper substrate.

The thermofusible synthetic compound in the paper substrate and before impregnation may be transparent, white, or colored, in particular with a color that may be the same or different from that of the cellulose fibers.

The paper substrate may be bleached or not. It may be colored or not.

Preferably, the dry weight composition of the paper substrate may be defined as follows: (% dry weight of cellulose fibers)+(% dry weight of thermofusible compound)+(% dry weight of filler and/or pigment)+dry weight of additives)=100% of dry weight of paper substrate.

The additives in the composition defined above represent less than 5% by dry weight of the paper substrate. Adjuvants may, for example, be selected from dry strength agents, wet strength agents, retention agents, fixing agents, and mixtures thereof.

The impregnating composition may have a solids content of between 20% and 60% by weight, preferably between 25% and 35% by weight.

The dry weight of the impregnating composition may be between 15% and 45%, preferably between 15% and 30%, of the total dry weight of the impregnated core paper.

The impregnated core paper may have a basis weight of between 50 and 400 g/m², preferably between 60 and 200 g/m². This is the basis weight of the paper substrate after impregnation with the impregnating composition.

### Manufacturing Method

It is a further subject-matter of the invention, independently or in combination with the foregoing, to provide a process for making an impregnated core paper as defined above, comprising impregnating a paper substrate with an aqueous impregnating composition comprising one or more resins selected from the group consisting of melamine-ether resins, acrylic resins, epoxy resins and mixtures thereof.

The paper substrate may be impregnated on-line on the paper machine, preferably by a glue press (also known as “size-press”) or similar equipment. The “size press” used for impregnating the paper substrate may be combined with a surface treatment device such as an air knife or doctor blade coaters (also known as “blade coating” machine), a curtain coating machine, a Champion coating machine, a gravure coating machine, a film-press coating machine or a spray coating device, such as a nozzle or a spray gun. This makes it possible to impregnate the paper substrate, followed by a surface treatment if necessary.

On-line production is understood to mean production on a single production tool with all the elements needed to produce the impregnated core paper.

On-line impregnation may significantly reduce the time and cost of manufacturing impregnated core paper. Compared to the off-line impregnation of Kraft paper sheets with conventional phenol-formaldehyde resins of the prior art, on-line impregnation thus improves the efficiency of the impregnated core paper manufacturing process, in particular by eliminating the additional operations associated with off-line impregnation.

The paper substrate may be impregnated at a paper speed of 300 m/min or more, in particular 400 m/min or even 450 m/min.

The paper substrate may be impregnated to a degree of saturation of between 15% and 45%, preferably between 15% and 30%, by dry weight.

The viscosity of the impregnating composition measured at 25° C. with a Brookfield viscometer (First-RM from Lamy Rheology) equipped with a mobile Spindle No. 2 at a shear rate of 100 rpm may be between 10 and 150 cPs, in particular between 20 and 80 cPs. Such viscosity values may, for example, correspond to impregnating compositions with a solids content, i.e., a dry extract, of about 30% by weight.

Such viscosity is compatible with on-line impregnation on the high-speed paper machine.

### Core

Another subject-matter of the invention, independently or in combination with the foregoing, is a core for a decorative laminate, in particular a high-pressure decorative laminate, comprising at least one sheet of core paper impregnated as described above or obtained according to the process as described above, in particular at least two sheets, better still between 10 and 100 sheets, better still between 20 and 50 sheets, at least partially, better completely, superimposed. The number of superimposed sheets forming the core may be selected according to the desired final thickness of the core.

Preferably, the impregnated core paper sheets are laminated together to form a core with cohesion between the sheets. The lamination is preferably carried out at a temperature between 30 and 150° C., and at a pressure of about 200 bar.

When tested in accordance with the DIN EN 438-2:2019-03 standard, the decorative laminate retains its cohesion after lamination, i.e., it shows no delamination after the boiling water immersion test.

### Decorative Laminate

Another subject-matter of the invention, independently or in combination with the foregoing, is a decorative laminate, in particular a high-pressure decorative laminate, comprising a core as described above, and in particular, at least one sheet of decorative paper, in particular, impregnated, placed upon (with the optional interposition of an intermediate sheet) at least one of the two opposing main surfaces of the core.

The intermediate sheet interposed between the sheet of decorative paper, in particular, impregnated, and one of the two opposing main surfaces of the core may be a contrasting paper sheet, for example.

The decorative laminate may comprise two sheets of impregnated decorative paper, each placed upon (with the optional interposition of an intermediate sheet) a respective main surface of the core.

Alternatively, the decorative laminate may comprise a sheet of impregnated decorative paper placed upon (with the optional interposition of an intermediate sheet) one of the two opposing major surfaces of the core and a support layer placed upon the other major surface of the core. The support layer may be a wood panel, such as chipboard.

### Core Paper

Another subject-matter of the invention, independently or in combination with the foregoing, is a core paper for decorative laminates, in particular high-pressure decorative laminates, comprising a paper substrate, the paper substrate comprising cellulose fibers, and at least one thermofusible synthetic compound in a mass ratio by dry weight greater than or equal to 1:1 and less than or equal to 15:1 of the totality of the cellulose fibers relative to the totality of the synthetic thermofusible compound(s), more preferably greater than or equal to 1:1 and less than or equal to 10:1, even more preferably greater than or equal to 1:1 and less than or equal to 4:1, and/or the paper substrate comprising at least one filler and/or at least one pigment, in particular selected from mineral pigments, such as for example titanium dioxide, clays, calcined clays, talc, calcium carbonate, iron oxides, kaolin, calcined kaolin, diatomaceous earths, silicas, in particular colloidal silicas, organic pigments, such as for example azo compounds or naphthols, synthetic pigments, barium sulphate, aluminum trihydrate and mixtures thereof, preferably selected from titanium dioxide, calcined clays and mixtures thereof.

Preferably, the paper substrate is capable of being impregnated with an aqueous impregnating composition comprising one or more resins selected from melamine-ether resins, acrylic resins, epoxy resins, and mixtures thereof.

The paper substrate may have any or all of the characteristics defined above for the paper substrate of the impregnated core paper.

### Use of Impregnated Core Paper

It is a further subject-matter of the invention, independently or in combination with the foregoing, to use an impregnated core paper as described above to manufacture a decorative laminate, in particular a high-pressure decorative laminate.

The decorative laminate may include a top layer, a backing layer, and at least one sheet of impregnated core paper according to the invention, placed between the top layer and the backing layer.

The top layer and the backing layer may be formed by an impregnated decor paper sheet, especially with a thermosetting resin composition.

For example, the decorative laminate comprises between the top layer and the backing layer at least two sheets of core paper impregnated according to the invention, better between 10 and 100 sheets, even better between 20 and 50 sheets, overlapping at least partially, better completely.

On the other hand, the decorative laminate may be laminated to a wood panel, such as a chipboard panel.

### BRIEF DESCRIPTION OF THE DRAWINGS

FIG. 1 is a partial schematic cross-section of an example of a decorative laminate according to the invention, and

FIG. 2 is a view similar to FIG. 1 of an alternative embodiment.

### DETAILED DESCRIPTION

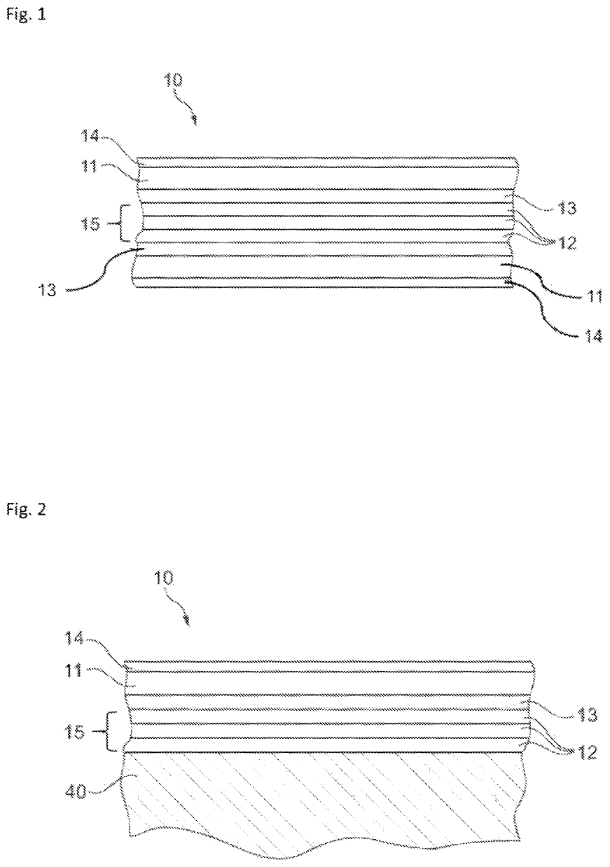

An example of a decorative laminate 10, specifically, a high-pressure decorative laminate, in accordance with the invention, is shown in FIG. 1. In this figure, the actual proportions are not shown for the sake of clarity.

The decorative laminate 10 includes a core 15 comprising three sheets of impregnated core paper 12 in accordance with the invention.

Of course, the number of impregnated core paper sheets 12 forming the core 15 shown in FIG. 1 is only a non-limiting example of an embodiment.

The core 15 may comprise between 1 and 100 sheets of impregnated core paper 12 according to the invention, in particular between 20 and 50 sheets of impregnated core paper 12 according to the invention.

The core 15 is covered on each of its two main opposing surfaces by a sheet of decorative paper 11.

Optionally, an intermediate sheet 13 such as a contrasting paper sheet may be interposed between the core 15 and any or all of the sheets of decorative paper 11.

Optionally, any or all of the sheets of decorative paper 11 may be covered on its outside by a protective sheet 14, called an “overlay.”

The decorative paper sheet 11 may be impregnated with resin, in particular, thermosetting resin, for example, melamine-formaldehyde resin.

In an embodiment illustrated in FIG. 2, the decorative laminate 10 comprises a sheet of decorative paper 11, in particular impregnated with resin, optionally covering an intermediate sheet 13 and a core 15 comprising one or more sheets of impregnated core paper 12 according to the invention.

The decorative paper sheet 11 may optionally be covered by a protective sheet 14, called an “overlay.”

The assembly constituted by the sheets of impregnated core paper 12 forming the core 15, by the sheet of decorative paper 11, by the optional intermediate sheet 13. and by the optional protective sheet 14 is glued on a support 40 such as chipboard, for example.

### EXAMPLES

The following examples serve only to illustrate the invention and are in no way intended to limit the invention. Indeed, various modifications of the invention, in addition to those described below, will become apparent to the skilled person from the above description and the examples below and will fall within the scope of the claims. The following tests were carried out in order to evaluate the properties of the impregnated core papers obtained according to the invention with respect to known counterexamples of the prior art (comparative examples).

TABLE 1
Influence of the Impregnation Composition

| | | | | Laminate obtained after lamination | | | |
|---|---|---|---|---|---|---|---|
| | | | | | | | Testing |
| | | | | | | | according |
| | Impregnated core paper | | | | | | to |
| | | Composition of | | Number | | | standard |
| | | the solid part (dry | | of sheets | | | DIN |
| | | extract) of the | Degree | of | | | EN |
| | Paper substrate | impregnation | of | impregnated | Core | | 438- |
| | before | composition | saturation | core | thickness | Laminate | 2:2019- |
| | impregnation | (% by weight) | (%) | paper | (μm) | cohesion | 03 |
| Prior Art | Kraft paper | 100% Phenol | N/A | 8 | 2369 | + | + |
| Reference | sheet | formaldehyde | | | | | |
| | | resin | | | | | |
| Example 1 | A | 100% | 21.4 | 20 | 2460 | + | + |
| (According to | | SA Latex 1 | | | | | |
| the invention) | | | | | | | |
| Example 2 | A | 100% | 21.4 | 20 | 2516 | + | + |
| (According to | | SA Latex 2 | | | | | |
| the invention) | | | | | | | |
| Example 3 | A | Vinyl acetate, | 20.9 | 20 | 2430 | + | − |
| (counter- | | vinyl chloride, | | | | | |
| example) | | ethylene | | | | | |
| | | copolymer | | | | | |
| Example 4 | A | 100% | 20.7 | 20 | 2572 | + | − |
| (counter- | | SB Latex | | | | | |
| example) | | | | | | | |
| Example 5 | A | 100% | 22.6 | 20 | 2532 | + | − |
| (counter- | | Polyurethane | | | | | |
| example) | | dispersion | | | | | |
| Example 6 | A | 100% | 20.9 | 20 | N/A | − | N/A |
| (counter- | | Modified paraffin | | | | | |
| example) | | wax emulsion | | | | | |
| Example 7 | A | 100% | 21.2 | 20 | N/A | − | N/A |
| (counter- | | Synthetic wax | | | | | |
| example) | | emulsion | | | | | |
| Example 8 | A | 100% | 17.9 | 20 | 2509 | + | − |
| (counter- | | Sulfo-polyester | | | | | |
| example) | | | | | | | |
| Example 9 | A | 75% SA latex, | 18.6 | 20 | 2546 | + | + |
| (According to | | 25% starch | | | | | |
| the invention) | | | | | | | |
| Example 10 | A | 50% SA latex, | 14.3 | 20 | N/A | − | N/A |
| (counter- | | 50% starch | | | | | |
| example) | | | | | | | |
| Example 11 | A | 25% SA latex, | 12.5 | 20 | N/A | − | N/A |
| (counter- | | 75% starch | | | | | |
| example) | | | | | | | |
| Example 12 | A | 100% Starch | 13.2 | 20 | N/A | − | N/A |
| (counter- | | | | | | | |
| example) | | | | | | | |
| Example 13 | B | 55% SA latex, | 19.8 | 40 | N/A | − | N/A |
| (counter- | | 45% starch | | | | | |
| example) | | | | | | | |
| Example 14 | B | 100% starch | 19.5 | 40 | N/A | − | N/A |
| (counter- | | | | | | | |
| example) | | | | | | | |
| Example 15 | B | 100% SA latex | 19.2 | 40 | 2592 | + | + |
| (According to | | | | | | | |
| the invention) | | | | | | | |
| Example 16 | B | 100% ULF | 19.1 | 40 | 2518 | + | + |
| (According to | | melamine-ether | | | | | |
| the invention) | | | | | | | |
| Example 17 | A | 100% ULF | 20.1 | 20 | 2543 | + | + |
| (According to | | melamine-ether | | | | | |
| the invention) | | | | | | | |
| Example 18 | B | 92% SA latex, 8% | 16.3 | 40 | 2385 | + | + |
| (According to | | PVOH | | | | | |
| the invention) | | | | | | | |
| Example 19 | B | 55% SA latex, | 19.1 | 40 | 2500 | + | − |
| (counter- | | 45% starch | | | | | |
| example) | | | | | | | |
| Example 20 | B | 70% SA latex, 5% | 19.6 | 40 | 2483 | + | + |
| (According to | | PVOH, 25% | | | | | |
| the invention) | | Melamine-ether | | | | | |
| Example 21 | A | 92% SA latex, 8% | 12.2 | 20 | 2558 | + | + |
| (According to | | PVOH | | | | | |
| the invention) | | | | | | | |
| Example 22 | A | 55%, SA latex, | 13.0 | 20 | N/A | − | N/A |
| (counter- | | 45% starch | | | | | |
| example) | | | | | | | |
| Example 23 | A | 70% SA latex, 5% | 22.4 | 20 | 2536 | + | + |
| (According to | | PVOH, 25% | | | | | |
| the invention) | | Melamine-ether | | | | | |
| Example 24 | B | 100% | 19.2 | 40 | 2313 | + | − |
| (counter- | | KEM-101-50 | | | | | |
| example) | | | | | | | |
| Example 25 | B | 86% KEM-101- | 18.9 | 40 | 2342 | + | + |
| (According to | | 50 + | | | | | |
| the invention) | | 14% KH 700 | | | | | |
| Example 26 | B | 86% KEM-101- | 20 | 40 | 2342 | + | + |
| (According to | | 50 + | | | | | |
| the invention) | | 14% KH 720 | | | | | |
| Example 27 | B | 86% Mixture 1:1 | 18.9 | 40 | 2367 | + | + |
| (According to | | KEM-101- | | | | | |
| the invention) | | 50/Acronal | | | | | |
| | | S305D + | | | | | |
| | | 14% KH 700 | | | | | |
| Example 28 | B | 86% Mixture 1:1 | 19.5 | 40 | 2390 | + | + |
| (According to | | KEM-101- | | | | | |
| the invention) | | 50/Acronal | | | | | |
| | | S305D + | | | | | |
| | | 14% KH 720 | | | | | |
| Example 29 | B | 86% Mixture 1:1 | 18.8 | 40 | 2422 | + | + |
| (According to | | KEM-101- | | | | | |
| the invention) | | 50/Stabilys A040 + | | | | | |
| | | 14% KH 720 | | | | | |

Paper substrate A: fiber = 100% cellulose, basis weight = 125 g/m², 0% pigments, Gurley porosity of 8 sec.
Paper substrate B: fiber = 100% cellulose, basis weight = 67 g/m², 23% pigments (TiO₂) in dry weight compared to the total dry weight of the paper substrate before impregnation, Gurley porosity of 10 sec.
SA Latex: styrene-acrylic latex
SB latex: styrene-butadiene latex
ULF Melamine-ether: “ultra-low formaldehyde” melamine-ether resin.
KEM-101-50: epoxy resin (polymer of 4,4′-(1-Methylethylidene) bisphenol with 2,2′-[(1-methylethylidene)bis(4,1-phenyleneoxymethylene)[bis[oxirane]; CAS: 25036-25-3)
KH 700: polyamine hardener (water soluble polyamine)
KH 720: polyamine hardener (polyamine emulsion)
Acronal S305D: styrene-acrylic latex
Stabilys A040: starch
Decorative laminate cohesion (+): presence of cohesion between the sheets of the decorative laminate after lamination
Decorative laminate cohesion (−): absence of cohesion between the sheets of the decorative laminate after lamination
Test according to the standard DIN EN 438-2:2019-03 (+): absence of delamination of the decorative laminate sheets
Test according to the standard DIN EN 438-2:2019-03 (−): delamination of decorative laminate sheets

In the examples in Table 1, two different paper substrates were size-press impregnated with different impregnation compositions and then dried to form impregnated core paper sheets 12.

A plurality of sheets of impregnated core paper 12 for each impregnating composition were then stacked to form a core 15, the core 15 being covered on its upper side with a sheet of impregnated decorative paper 11, and optionally on its underside with another sheet of impregnated decorative paper 11. The assembly was then laminated to form a decorative laminate 10. The laminating conditions used are as follows:
in a first step lasting 30 minutes, a temperature rise from 30° C. to 150° C. is applied to the stack, then
in a second step lasting 12.5 minutes, the temperature applied to this stack is maintained at 150° C., then
in a third step lasting 5 minutes, the temperature applied to the stack is lowered from 30° C. to 150° C., then A pressure of approximately 10 MPa is applied to the decorative laminate 10 during all three steps above.

When the decorative laminate 10 shows cohesion after laminating the impregnated core paper sheets 12, this decorative laminate 10 is subjected to the test according to the standard DIN EN 438-2:2019-03, which consists of immersing the decorative laminate 10 in boiling water for 2 hours and then evaluating the swelling of the decorative laminate 10 and a possible delamination of the individual sheets forming the decorative laminate 10.

The impregnating compositions comprise about 30% by weight solids (i.e., about 30% solids by weight) and 70% water by weight. The composition of the solid part (dry extract) of the different impregnation compositions is shown in Table 1.

It may be seen in Table 1 that the impregnation compositions of Examples 6, 7, 10-14, and 22 do not result in a decorative laminate 10 with cohesion after laminating the impregnated core paper sheets 12.

The impregnation compositions of Examples 3-5, 8, 19, and 24 provide a decorative laminate 10 with cohesion after laminating the impregnated core paper sheets 12, but the decorative laminate 10 loses cohesion and delaminates when tested according to the standard DIN EN 438-2:2019-03.

Similar to the example of prior art reference, the impregnation compositions of Examples 1, 2, 9, 15-18, 20, 21, 23, 25-29 (examples according to the invention) provide a decorative laminate 10 that exhibits cohesion after laminating the impregnated core paper sheets 12, and this cohesion is retained when the decorative laminate 10 is subjected to the standard DIN EN 438-2:2019-03 test. Thus, the examples according to the invention have similar performance to the example of prior art reference.

TABLE 2
Influence of the Presence of Fillers and/or Pigments in the Paper Substrate

| | Impregnated core paper | | | | | | |
|---|---|---|---|---|---|---|---|
| | | | | | Fillers or | | |
| | | | | | Pigments | Laminate obtained | |
| | | | | | (in dry | after lamination | |
| | | | Composition of | | weight in | | Testing |
| | | | the solid part | | relation to | | according |
| | | | (dry extract) of | | the total dry | | to the |
| | Paper substrate before | | the | | weight of | | standard |
| | impregnation | | impregnation | Degree of | the | | DIN EN |
| | Reference | | composition | saturation | impregnated | Laminate | 438- |
| | No. | Fibers | (% by weight) | (%) | core paper) | cohesion | 2:2019-03 |
| Example 30 | C | 100 parts | 100% ULF | 18.6 | 0% | + | + |
| (According | | natural | melamine- | | | | |
| to the | | cellulose | ether | | | | |
| invention) | | | | | | | |
| Example 31 | C | 100 parts | 100% ULF | 20.7 | 20% | + | ++ |
| (According | | natural | melamine- | | calcined | | Compared |
| to the | | cellulose | ether | | clay | | with |
| invention) | | | | | | | Example |
| | | | | | | | 30 |
| Example 32 | C | 100 parts | 100% ULF | 17.8 | 20% TiO₂ | + | ++ |
| (According | | natural | melamine- | | | | Compared |
| to the | | cellulose | ether | | | | with |
| invention) | | | | | | | Example |
| | | | | | | | 30 |
| Example 33 | C | 100 parts | 55% SA latex, | 11.7 | 0% | − | N/A |
| (counter- | | natural | 45% starch | | | | |
| example) | | cellulose | | | | | |
| Example 34 | C | 100 parts | 55% SA latex, | 12.3 | 22% clay | + | − |
| (counter- | | natural | 45% starch | | | | |
| example) | | cellulose | | | | | |
| Example 35 | C | 100 parts | 55% SA latex, | 11.7 | 22% talc | + | − |
| (counter- | | natural | 45% starch | | | | |
| example) | | cellulose | | | | | |
| Example 36 | C | 100 parts | 55% SA latex, | 14.3 | 21% | + | + |
| (According | | natural | 45% starch | | calcined | | |
| to the | | cellulose | | | clay | | |
| invention) | | | | | | | |
| Example 37 | C | 100 parts | 55% SA latex, | 14.9 | 21% TiO₂ | + | + |
| (According | | natural | 45% starch | | | | |
| to the | | cellulose | | | | | |
| invention) | | | | | | | |

C: basis weight = 80 g/m²; refining energy = 150 kWh/t
Decorative laminate cohesion (+): presence of cohesion between the sheets of the decorative laminate after lamination
Decorative laminate cohesion (−): absence of cohesion between the sheets of the decorative laminate after lamination
Test according to the standard DIN EN 438-2:2019-03 (+): absence of delamination of the decorative laminate sheets
Test according to the standard DIN EN 438-2:2019-03 (++): improvement in strength
Test according to the standard DIN EN 438-2:2019-03 (−): delamination of decorative laminate sheets

In the examples in Table 2, paper substrates containing various fillers or pigments in their mass were impregnated by size-press with an impregnating composition (at 30% dry matter) containing either 100% by weight of a ULF melamine-ether resin (100% by weight of dry matter), or 55% by weight (55% by weight of dry matter) of a styrene-acrylic latex (SA Latex) and 45% by weight (45% by weight of dry matter) of starch, and then dried so as to form impregnated core paper sheets 12.

Similar to the examples in Table 1, the impregnated core paper sheets 12 were then laminated together under the laminating conditions indicated for the tests in Table 1 to form a decorative laminate 10. When the decorative laminate 10 shows cohesion after laminating the impregnated core paper sheets 12, this decorative laminate 10 is subjected to the test according to the standard DIN EN 438-2:2019-03, which consists of immersing the decorative laminate 10 in boiling water for 2 hours and then evaluating the swelling of the decorative laminate 10 and a possible delamination of the individual sheets forming the decorative laminate 10.

By comparing Examples 30 to 32, it may be observed that the presence of 20% dry weight of calcined clay (Example 31) or TiO₂ (Example 32) based on the total dry weight of the paper substrate after impregnation improves the strength of the decorative laminate 10 to the test according to the standard DIN EN 438-2: 2019-03 because the increase in thickness and the increase in mass of the decorative laminate 10 as a result of the test according to the standard DIN EN 438-2:2019-03 are limited in Examples 31 and 32 compared to the results obtained for example 30.

By comparing Examples 33 to 35, it may be seen that the presence of 22% dry weight of clay (Example 34) or talc (Example 35) based on the total dry weight of the paper substrate after impregnation provides cohesion to the decorative laminate 10 obtained by laminating the impregnated core sheets 12. On the other hand, the presence of these fillers does not maintain the cohesion of the decorative laminate 10 when tested according to the standard DIN EN 438-2:2019-03 since delamination is observed.

By comparing Examples 33 and 36-37, it may be seen that the presence of 21% dry weight of calcined clay (Example 36) or TiO₂ (Example 37) based on the total dry weight of the paper substrate after impregnation results in a cohesive decorative laminate 10, the cohesion of which is maintained when the decorative laminate 10 is subjected to the standard DIN EN 438-2:2019-03 test.

Thus, for a given impregnation composition, the presence of fillers and/or pigments in the mass of the paper substrate may increase the cohesion of the decorative laminate 10 obtained by laminating the impregnated core paper sheets 12 and/or its test strength according to the standard DIN EN 438-2:2019-03. This effect may be explained by the fact that the presence of fillers and/or pigments results in a modification of the porous structure of the paper substrate, which allows its impregnation in a faster and more homogeneous way. Thus, for given impregnation conditions, the degree of saturation, i.e., of the amount of impregnating composition in the impregnated core paper 12, is increased.

For a given paper substrate and given impregnation conditions, the variations in the degree of saturation obtained for different impregnation compositions may be explained by the variations in viscosity of the impregnation composition. The less viscous the impregnating composition is, the more it will penetrate the paper substrate, and therefore the higher the degree of saturation.

TABLE 3
Influence of the Presence of Synthetic Fibers in the Paper Substrate

| | Impregnated core paper | | | | | | |
|---|---|---|---|---|---|---|---|
| | | | | | Fillers or | Laminate obtained | |
| | | | | | Pigments | after lamination | |
| | | | Composition | | (in dry | | Testing |
| | | | of the solid | | weight in | | according |
| | | | part (dry | | relation to | | to the |
| | | | extract) of the | | the total dry | | standard |
| | Paper substrate before | | | | weight of | | |
| | impregnation | | impregnation | Degree of | the | | DIN EN |
| | Reference | | composition | saturation | impregnated | Laminate | 438- |
| | No. | Fibers | (% by mass) | (%) | core paper) | cohesion | 2:2019-03 |
| Example | C | 100 parts | 100% ULF | 17.8 | 20% TiO₂ | + | + |
| 32 | | natural | melamine- | | | | |
| (According | | cellulose | ether | | | | |
| to the | | | | | | | |
| invention) | | | | | | | |
| Example | C | 80 parts | 100% ULF | 18.3 | 20% TiO₂ | + | ++ |
| 38 | | natural | melamine- | | | | Compared |
| (According | | cellulose | ether | | | | with |
| to the | | + | | | | | Example |
| invention) | | 20 parts | | | | | 32 |
| | | Kuralon | | | | | |
| | | VPB 101 | | | | | |
| Example | C | 60 parts | 100% ULF | 19.2 | 20% TiO₂ | + | ++ |
| 39 | | natural | melamine- | | | | Compared |
| (According | | cellulose | ether | | | | with |
| to the | | + | | | | | Example |
| invention) | | 40 parts | | | | | 38 |
| | | Kuralon | | | | | |
| | | VPB 101 | | | | | |
| Example | C | 80 parts | 100% ULF | 19.8 | 20% TiO₂ | + | ++ |
| 40 | | natural | melamine- | | | | Compared |
| (According | | cellulose + | ether | | | | with |
| to the | | 20 parts | | | | | Example |
| invention) | | N720 | | | | | 32 |
| Example | C | 60 parts | 100% ULF | 21.6 | 20% TiO₂ | + | ++ |
| 41 | | natural | melamine- | | | | Compared |
| (According | | cellulose | ether | | | | with |
| to the | | + | | | | | Example |
| invention) | | 40 parts | | | | | 40 |
| | | N720 | | | | | |
| Example | C | 80 parts | 100% ULF | 20.2 | 20% TiO₂ | + | ++ |
| 42 | | natural | melamine- | | | | Compared |
| (According | | cellulose | ether | | | | with |
| to the | | + | | | | | Example |
| invention) | | 20 parts | | | | | 32 |
| | | N720H | | | | | |
| Example | C | 60 parts | 100% ULF | 22.5 | 19% TiO₂ | + | ++ |
| 43 | | natural | melamine- | | | | Compared |
| (According | | cellulose | ether | | | | with |
| to the | | + | | | | | Example |
| invention) | | 40 parts | | | | | 42 |
| | | N720H | | | | | |
| Example | C | 100 parts | 55% SA latex, | 14.9 | 21% TiO₂ | + | + |
| 37 | | natural | 45% starch | | | | |
| (According | | cellulose | | | | | |
| to the | | | | | | | |
| invention) | | | | | | | |
| Example | C | 80 parts | 55% SA latex, | 17.6 | 21% TiO₂ | + | ++ |
| 44 | | natural | 45% starch | | | | Compared |
| (According | | cellulose | | | | | with |
| to the | | + | | | | | Example |
| invention) | | 20 parts | | | | | 37 |
| | | Kuralon | | | | | |
| | | VPB 101 | | | | | |
| Example | C | 60 parts | 55% SA latex, | 17.9 | 20% TiO₂ | + | ++ |
| 45 | | natural | 45% starch | | | | Compared |
| (According | | cellulose + | | | | | with |
| to the | | 40 parts | | | | | Example |
| invention) | | Kuralon | | | | | 44 |
| | | VPB 101 | | | | | |
| Example | C | 80 parts | 55% SA latex, | 18.1 | 20% TiO₂ | + | ++ |
| 46 | | natural | 45% starch | | | | Compared |
| (According | | cellulose | | | | | with |
| to the | | + | | | | | Example |
| invention) | | 20 parts | | | | | 37 |
| | | N720 | | | | | |
| Example | C | 60 parts | 55% SA latex, | 19.4 | 20% TiO₂ | + | ++ |
| 47 | | natural | 45% starch | | | | Compared |
| (According | | cellulose | | | | | with |
| to the | | + | | | | | Example |
| invention) | | 40 parts | | | | | 46 |
| | | N720 | | | | | |
| Example | C | 80 parts | 55% SA latex, | 17.9 | 20% TiO₂ | + | ++ |
| 48 | | natural | 45% starch | | | | Compared |
| (According | | cellulose | | | | | with |
| to the | | + | | | | | Example |
| invention) | | 20 parts | | | | | 37 |
| | | N720H | | | | | |
| Example | C | 60 parts | 55% SA latex, | 20.1 | 20% TiO₂ | + | ++ |
| 49 | | natural | 45% starch | | | | Compared |
| (According | | cellulose + | | | | | with |
| to the | | 40 parts | | | | | Example |
| invention) | | N720H | | | | | 48 |

C: basis weight = 80 g/m²; refining energy = 150 kWh/t
SA Latex: styrene-acrylic latex
ULF Melamine Ether: “ultra-low formaldehyde” melamine-ether resin
Kuralon VPB 101: PVA synthetic fibers (2.9 dtex; 17 μm diameter; 4 mm length; melting point: 80° C.)
N720: bi-component polyester/PET synthetic fibers (2.2 dtex; 14 μm diameter; 5-10 mm length; melting point 110° C.)
N720H: bi-component polyester/PET synthetic fibers (2.3 dtex; 15 μm diameter; 5 mm length; melting point: 130° C.)
Decorative laminate cohesion (+): presence of cohesion between the sheets of the decorative laminate after lamination
Decorative laminate cohesion (−): absence of cohesion between the sheets of the decorative laminate after lamination
Test according to the standard DIN EN 438-2:2019-03 (+): absence of delamination of the decorative laminate sheets
Test according to the standard DIN EN 438-2:2019-03 (++): improvement in strength
Test according to the standard DIN EN 438-2:2019-03 (−): delamination of decorative laminate sheets

In the examples in Table 3, paper substrates containing 20% TiO₂ by dry weight based on the total dry weight of the paper substrate after impregnation and different mixtures of cellulose fibers and synthetic fibers were impregnated by size-press with an impregnating resin containing in dry extract either 100% by weight of a ULF melamine-ether resin or 55% by weight of a styrene-acrylic latex (SA Latex) and 45% by weight of starch, and then dried to form impregnated core paper sheets 12.

Similar to the examples in Table 1 and 2, the impregnated core paper sheets 12 were then laminated together under the laminating conditions indicated for the tests in Table 1 to form a decorative laminate 10. When the decorative laminate 10 shows cohesion after laminating the impregnated core paper sheets 12, this decorative laminate 10 is subjected to the test according to the standard DIN EN 438-2:2019-03, which consists of immersing the decorative laminate 10 in boiling water for 2 hours and then evaluating the swelling of the decorative laminate 10 and optional delamination of the individual sheets 12 forming the core 15.

By comparing Examples 32 and 38, 32 and 40, 32 and 42, we see that the presence of synthetic fibers in the paper substrate makes it possible to improve the strength of the decorative laminate 10 when tested according to the standard DIN EN 438-2:2019-03 because the increase in thickness and the increase in mass of the decorative laminate 10 as a result of the test according to the standard DIN EN 438-2:2019-03 are reduced in Examples 38, 40 and 42 in comparison to Example 32. The same observations are made when comparing Examples 37 and 44, 37 and 46, 37 and 48.

By comparing Examples 38 and 39, 40 and 41, 42 and 43, we see that increasing the proportion of synthetic fibers within the paper substrate further improves the strength of the decorative laminate 10 against the standard DIN EN 438-2:2019-03 test. The same observations are made when comparing Examples 44 and 45, 46 and 47, 48 and 49.

Thus, for a given impregnation composition, the presence of synthetic fibers in the paper substrate may increase the strength of the decorative laminate 10 obtained by laminating the impregnated core paper sheets 12 to the test according to the standard DIN EN 438-2:2019-03. This effect may be explained by the fact that the presence of synthetic fibers makes it possible to increase, for given impregnation conditions, the degree of saturation, i.e., the amount of impregnation composition in the impregnated core paper 12.

Furthermore, the examples in Table 3 show that for a given impregnation composition and a given proportion of synthetic fibers in the paper substrate, the strength is improved as the melting point of the synthetic fibers increases. This may be explained by the fact that a sufficiently high melting point of the synthetic fibers allows the synthetic fibers to melt only during the HPL laminating process carried out under heat and not beforehand, especially during the production of the paper substrate on the paper machine. Melting the synthetic fibers during laminating then allows the synthetic fibers to act as an adhesive between the impregnated core paper sheets 12 (heat bonding) and thus increase the cohesion and strength of the core 15 and thus the decorative laminate 10.

As will be understood from the preceding description of the present invention and the illustrative experimental examples, the present invention can be described by reference to the following embodiments:
1. Impregnated core paper (12) for a decorative laminate (10), in particular high-pressure decorative laminate, obtained by impregnating a paper substrate with an aqueous impregnating composition comprising one or more resins selected from melamine-ether resins, acrylic resins, epoxy resins, and mixtures thereof.
2. Impregnated core paper (12) according to embodiment 1, characterized in that the impregnating composition comprises a melamine-ether resin, in particular at least 90%, better still at least 95%, by dry weight of a melamine-ether resin, or an acrylic resin, in particular at least 90%, better still at least 95%, by dry weight of an acrylic resin, or a mixture of epoxy resin and hardener, in particular at least 90%, better still at least 95%, by dry weight of this mixture.
3. Impregnated core paper (12) according to embodiment 1 or 2, characterized in that the impregnating composition comprises a water-soluble polymer, in particular selected from a starch, a modified starch, a polyvinyl alcohol, and mixtures thereof.
4. Impregnated core paper (12) according to any of the preceding embodiments, characterized in that the paper substrate comprises at least 45% dry weight, better still at least 90% dry weight, even better still at least 95% dry weight, of cellulosic fibers based on the total dry weight of the paper substrate.
5. Impregnated core paper (12) according to any of the preceding embodiments, characterized in that the paper substrate comprises cellulose fibers and at least one thermofusible synthetic compound in a mass ratio by dry weight greater than or equal to 1:1 and less than or equal to 15:1 of the totality of the cellulose fibers relative to the totality of the thermofusible synthetic compound(s), more preferably greater than or equal to 1:1 and less than or equal to 10:1, even more preferably greater than or equal to 1:1 and less than or equal to 4:1.
6. Impregnated core paper (12) according to embodiment 5, characterized in that the thermofusible synthetic compound comprises or consists of a thermoplastic polymer, the thermoplastic polymer being selected in particular from the families of acrylic polymers, polyurethanes, polyolefins, especially polyethylene (PE) polypropylene (PP), ethylene-vinyl acetate (EVA), ethylene acrylic acid (EAA), ethylene methacrylate (EMA), ethylene methyl methacrylate (EMMA), polyvinylidene chloride (PVDC), polyesters (PES) especially polyethylene terephthalate (PET), polylactic acid (PLA), polyamides, polyvinyl alcohol (PVA or PVOH), polyvinyl chloride (PVC), ethylene vinyl alcohol (EVOH), polyvinylidene fluoride (PVDF) their copolymers and mixtures thereof, the thermofusible synthetic compound being in particular in the form of fibers, in particular selected from among single-component, multi-component, in particular two-component fibers, and mixtures thereof.
7. Impregnated core paper (12) according to any of the preceding embodiments, characterized in that the dry weight of the impregnating composition is between 15% and 45%, preferably between 15% and 30%, of the total dry weight of the impregnated core paper.
8. Impregnated core paper (12) according to any of the preceding embodiments, characterized in that the impregnated core paper (12) has a weight of between 50 and 400 g/m², preferably between 60 and 200 g/m².
9. Impregnated core paper (12) according to any of the preceding embodiments, characterized in that the paper substrate comprises at least one filler and/or at least one pigment, in particular selected from mineral pigments, such as for example titanium dioxide, clays, calcined clays, talc, calcium carbonate, iron oxides, kaolin, calcined kaolin, diatomaceous earth, silicas, especially colloidal silicas, organic pigments, such as azo compounds or naphthols, synthetic pigments, barium sulfate, aluminum tri-hydrate and mixtures thereof, preferably selected from titanium dioxide, calcined clays and mixtures thereof.
10. Impregnated core paper (12) according to embodiment 9, characterized in that the dry weight of the filler and/or pigment is between 5% and 40%, preferably between 8% and 36%, of the total dry weight of the impregnated core paper.
11. Method of manufacturing an impregnated core paper (12) according to any of embodiments 1 to 10, comprising impregnating a paper substrate with an aqueous impregnating composition comprising one or more resins selected from melamine-ether resins, acrylic resins, epoxy resins, and mixtures thereof.
12. Method according to embodiment 11, characterized in that the paper substrate is impregnated in line on the paper machine, preferably by size-press.
13. Method according to embodiment 11 or 12, characterized in that the paper substrate is impregnated to a degree of saturation of between 15% and 45%, preferably between 15% and 30%, by dry weight.

14. Core (15) for a decorative laminate (10), in particular a high-pressure decorative laminate, comprising at least one sheet of impregnated core paper (12) as defined according to any of embodiments 1 to 10 or obtained according to the process as defined in any of embodiments 11 to 13, in particular at least two sheets, preferably between 10 and 100 sheets, even better between 20 and 50 sheets, overlapping at least partially, better still completely.
15. A decorative laminate (10), in particular a high-pressure decorative laminate, comprising a core (15) according to embodiment 14, and in particular at least one impregnated decorative paper sheet (11) placed upon at least one of the two opposite main surfaces of the core (15).

1. An impregnated core paper for a decorative laminate, obtained by impregnating a paper substrate with an aqueous impregnating composition comprising one or more resins selected from melamine-ether resins, acrylic resins, epoxy resins, and mixtures thereof.

2. The impregnated core paper according to claim 1, wherein the impregnating composition is substantially free of phenol-formaldehyde resin.

3. The impregnated core paper according to claim 1, wherein the impregnating composition comprises a water-soluble polymer.

4. The impregnated core paper according to claim 1, wherein the paper substrate comprises at least 45% dry weight of cellulosic fibers based on the total dry weight of the paper substrate.

5. The impregnated core paper according to claim 1, wherein the paper substrate comprises cellulose fibers and at least one thermofusible synthetic compound in a mass ratio by dry weight greater than or equal to 1:1 and less than or equal to 15:1 of the totality of the cellulose fibers relative to the totality of the thermofusible synthetic compound(s).

6. The impregnated core paper according to claim 5, wherein the thermofusible synthetic compound comprises or consists of a thermoplastic polymer.

7. The impregnated core paper according to claim 1, wherein the dry weight of the of the impregnating composition is between 15% and 45% of the total dry weight of the impregnated core paper.

8. The impregnated core paper according to claim 1, wherein the impregnated core paper has a basis weight of between 50 and 400 g/m².

9. The impregnated core paper according to claim 1, wherein the paper substrate comprises at least one filler and/or at least one pigment.

10. The impregnated core paper according to claim 9, wherein the dry weight of the filler and/or pigment is between 5% and 40% of the total dry weight of the impregnated core paper.

11. The impregnated core paper according to claim 1, wherein the impregnating composition is substantially free of free-formaldehyde.

12. A method of manufacturing an impregnated core paper according to claim 1, comprising impregnating a paper substrate with an aqueous impregnating composition comprising one or more resins selected from melamine-ether resins, acrylic resins, epoxy resins, and mixtures thereof.

13. The method according to claim 12, wherein the paper substrate is impregnated online on the paper machine.

14. The method according to claim 12, characterized in that the paper substrate is impregnated to a degree of saturation of between 15 and 45% by dry weight.

15. A core for a decorative laminate, comprising at least one sheet of impregnated core paper as defined according to claim 1 or obtained according to the process as defined in claim 12, overlapping at least partially.

16. A decorative laminate, comprising a core according to claim 15.
